(19) United States
(12) Patent Application Publication
(10) Pub. No.: US 2009/0094593 A1
(43) Pub. Date: Apr. 9, 2009

(54) WIRELESSLY UPGRADING SOFTWARE IN A MOBILE COMPUTING DEVICE

(76) Inventor: Richard L. Jaung, Dix Hills, NY (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/868,326

(22) Filed: Oct. 5, 2007

(51) Int. Cl. G06F 9/44

(52) U.S. Cl. 717/173

(57) ABSTRACT

A system comprises a wireless mobile computing device that executes software contained therein. The system also comprises a host system configured to wirelessly communicate with the wireless mobile computing device. The host system verifies that the wireless mobile computing device is authorized to receive a software upgrade and, if so, wirelessly transmits data to the wireless mobile computing device to upgrade the software.

### BACKGROUND

Many police vehicles include a wireless electronic device that enables the police officer to receive dispatches and to query police records. Such devices generally comprise computers that execute software. From the time to time, software updates are created. Unfortunately, upgrading the software can be a time consuming, burdensome process in which the upgrade is scheduled and the vehicle is taken out of commission.

### BRIEF DESCRIPTION OF THE DRAWINGS

For a detailed description of exemplary embodiments of the invention, reference will now be made to the accompanying drawings in which:

FIG. 1 shows a system in accordance with various embodiments;

FIG. 2 shows a block diagram implementation of the mobile communication device or host system of FIG. 1 in accordance with various embodiments;

FIG. 3 conceptualizes the process of wirelessly transmitting the software upgrade to the mobile communication device; and

FIG. 4 shows a method in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

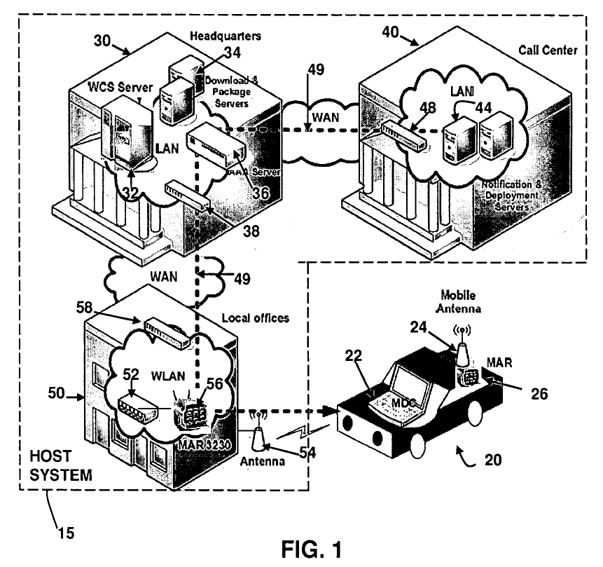

FIG. 1 illustrates a police vehicle 20 in close proximity to a local office 50. In practice, more than one police vehicle 20 is implemented and more than one local office 50 is also provided. The police vehicle 20 is representative of a wide variety of emergency vehicles such as those used by police, fire, ambulance, etc. personnel. The police vehicle 20 comprises a wireless mobile computing device 22. In some embodiments, the wireless mobile computing device 22 comprises a ruggedized laptop computer such as a mobile data computer (MDC). An exemplary MDC is the M5 Mobile Computer System from Data911.

The vehicle's wireless mobile computing device 22 includes or couples to a mobile access router (MAR) 26 and antenna 24. In this disclosure, the mobile computing device 22, alone or in combination with either or both of the MAR 26 and antenna 24, is referred to as a “wireless computing device.” An illustrative MAR comprises, for example, the MAR 3230 provided by Cisco Systems. The antenna 24 enables wireless connectivity between the computing device 22 and a host system 15. In some embodiments, the functionality of the MAR 26 and/or the antenna 24 is integrated into the MDC 22.

In various embodiments, the host system 15 comprises multiple server computers (“servers”), switches, storage devices, and other equipment. In the example of FIG. 1, the host system 15 comprises equipment installed in each of the local offices 50, the headquarters building 30, and the cell center 40. Each local office 50 comprises a MAR 56 coupled to an antenna 54, as well as a hub 52 and a switch 58, which provides network connectivity (e.g., wide area network connectivity) to a corresponding switch 38 at headquarters 30.

Headquarters 30 comprises a wireless controller server (WCS) 32, download and package servers 34 and an Authorization and Accounting (AAA) server 36. The WCS server controls wireless data and software upgrade traffic. The download and package servers 34 will download and package software patches and new definitions. The AAA server 36 is responsible for managing supported attributes that are available to the various services within the system.

The call center 40 comprises a switch 48 which enables wide area network connectivity to the host equipment in headquarters 30. The call center 40 also comprise notification and deployment servers 44 are operated by personnel in the call center to receive emergency calls and communicate with the MDCs 22 of the various police vehicles 20 to dispatch emergency personnel as appropriate.

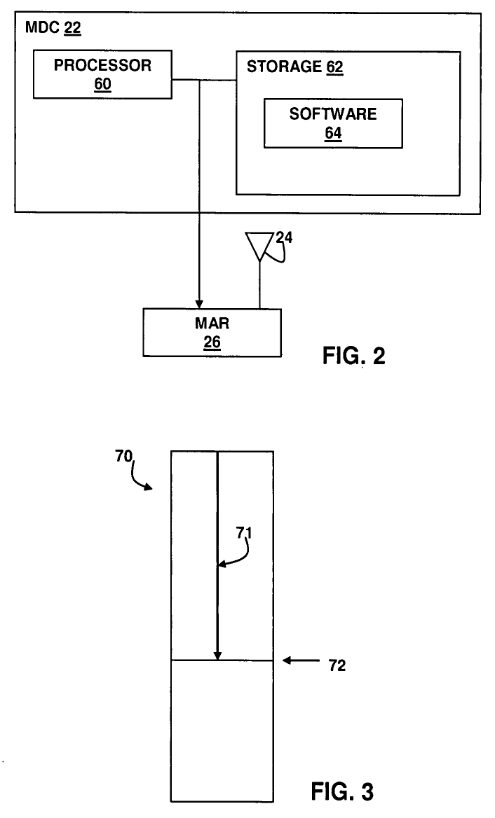

FIG. 2 provides an illustrative embodiment of each MDC 22 and its connection to the MAR 26 and antenna 24. In this embodiment, each MDC 22 comprises a processor 60 coupled to storage 62. The storage 62 comprises volatile memory (e.g., random access memory), non-volatile storage (e.g., hard disk drive, read-only memory, compact disc read-only memory (CD ROM), etc.), or combinations thereof. The storage 62 comprises software 64. Software 64 is code that is executable on processor 60. Software 62 may comprise an operating system and/or one or more applications and drivers that run under the control of such an operating system. The architecture for the MDC 22 depicted in FIG. 2 also applies to any of the other servers of the host system 15 in the local offices 50, headquarters 30 and call center 40.

The software 64 of the MDC 22 can be wirelessly upgraded in accordance with various embodiments. A software upgrade is created and/or provided on the notification and deployment servers 44, transferred to the AAA server 36, and then relayed to the MAR 56 of each local office 50 (as indicated by dashed arrow 49). When a police vehicle 20 “nears” a local office 50, the MAR 56 in the local house begins to automatically and wirelessly transmit the software upgrade, via antenna 24 and MAR 26, to the MDC 22 of the police vehicle 20. Driving “near” the local office means that the antenna 24 and MAR 26 of the vehicle 20 are within wireless communication range of the antenna 54 and MAR 56 of the local office 50. In at least some embodiments, the MARs 56 and 24 operate in either or both of the 2.4 GHz or 4.9 GHz frequency bands. In some embodiments, the default frequency band is the 4.9 GHz frequency which may provide a 6 megabit per second (Mbs) data rate and has a range of approximately 150 feet. If, for some reason, wireless communications using the 4.9 GHz frequency band is unavailable, the MARs 56 and 26 use the 2.4 GHz frequency band in compliance with, for example, IEEE 802.11b/g as a back-up wireless communication protocol.

In some embodiments, as a security precaution, the MAR 56 will not begin to transmit the software upgrade to the MDC 22 without first verifying that the MDC 22 is authorized to receive the upgrade. Such security can be provided in accordance with any of a variety of techniques. One such technique involves the host system 15 (e.g., MAR 56) requesting the MDC 22 to transmit to the host system a value that identifies the MDC 22 to the host system. Such a value may comprise, for example, the serial number of the MDC 22. In some embodiments, the MDC-identifying value is encrypted by the MDC 22 and/or sent in encrypted form to the host system. The host system 15 decrypts the identifying value (if it was encrypted in the first place) and verifies the validity of the identifying value. For example, the host system 15 (e.g., the download and packaging servers 34), compares the identifying value received from the MDC 22 against a list of known legitimate MDC-identifying values, pre-programmed into the host system 15 by operators of the host system 15. If the MDC's identifying value is successfully validated, the wireless transmission of the software upgrade proceeds automatically. If the MDC's identifying value is not successfully validated, the transmission of the software upgrade will not proceed. In this latter situation (failure to validate the MDC-identifying value), the host system 15 may simply avoid transmitting the software upgrade to the invalid MDC. In yet other embodiments, the host system may report or otherwise annunciate the failure (e.g., activate an alarm, send a warning message to a person in the call center 40 or local office 50, etc.).

Following validation of the MDC 22, the software upgrade occurs “automatically” in at least some embodiments, meaning that a user (e.g., a policeman driving the vehicle 20) need not prompt the MDC 22 to begin the software upgrade (i.e., no prompt is provided on the MDC 22 to begin the software upgrade process). However, in other embodiments, the operator of the MDC 22 is prompted to begin the software upgrade. If desired, a biometric sensor 23 (e.g., fingerprint or retinal scanner), may be provided on or with the MDC 22. Successful biometric verification may be required before the transmission of the software upgrade can occur. Either the MDC 22 or the host system 15 can be used to authenticate the user via such a biometric sensor.

It is possible that the wireless transmission of the software download to the MDC 22 will be interrupted before it has a chance to complete. An interruption may occur, for example, due to a police vehicle 20, which is presently parked near a local office 50, being called away on an emergency. Once the vehicle 20 leaves the communication range of the local office 50 broadcasting the software upgrade, the wireless communication link between the antennas 24 and 54 will cease thereby interrupting the transmission of the software upgrade. FIG. 3 conceptually indicates the process of wirelessly transmitting a software upgrade 70 to the MDC 22. The software upgrade 70 may comprise one or more files that are transmitted to the MDC 22. The transmission occurs as indicated by arrow 71. At point 72 during the transmission of the software upgrade, the transmission is interrupted. The host system 15 (e.g., the download and packaging servers 34 at headquarters 30 and/or the notification and deployment servers 44 at the call center) maintains (e.g., updates) a software/hardware pointer that keeps track of where in the transmission process the interrupt occur. Then, when that same vehicle 20 nears (e.g., comes within wireless communication range of) the same or different local office 50, the transmission of the software upgrade process can continue at point 72, as identified by the pointer. Thus, the software upgrade process in such embodiments need not start over.

Once the new software has been wirelessly transmitted through antenna 24 and MAR 26 to the MDC 22, the MDC 22 implements the upgrade. The implementation of the upgrade depends on the nature of the upgrade. In some cases, the upgrade may only entail amending an existing file on the MDC (e.g., updating an anti-virus definition file). In other cases, the upgrade may entail replacing an existing executable file with a new executable file. In yet other cases, the update entails both a replacement of an executable file as well as a change to an existing file. In some cases, the implementation of the upgrade may require the MDC 22 to be rebooted (also referred to as re-initialized, power-cycled, etc.). A button may be provided on the MDC to cause a reboot. Alternatively, the MDC 22 may be powered down upon the ignition of the vehicle being turned off. Consequently, the MDC 22 is powered back up when the vehicle is started.

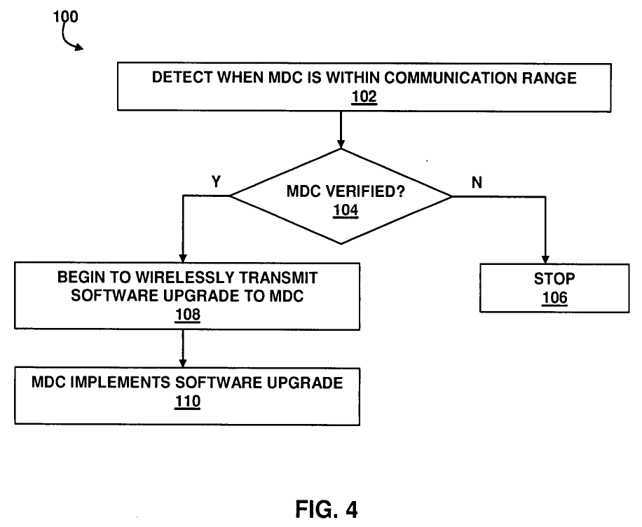

FIG. 4 illustrates a method 100 embodiment. At 102, the method comprises detecting when the MDC 22 is within communication range of a local office having the wireless capability described herein. In some embodiments, the local office's antenna 54 or the vehicle 20 emits a periodic beacon signal which is responded to by the other of the antenna 54 or vehicle 20 when the vehicle is near the local office. When in range, a reply message to the beacon is transmitted. Reception of the beacon reply indicates that a vehicle is near the local office.

At 104, the host system 15 verifies the MDC 22. If the host system cannot verify the MDC 22, the process terminates at 106 (along with annunciating an alarm or taking other corrective action as desired). However, if the host system successfully verifies the MDC 22, then at 108 method 100 comprises beginning to wirelessly transmit the software upgrade to the MDC 22. As explained above, the action of transmitting the upgrade to the MDC 22 may be interrupted, but will resume when wireless connectivity is re-established between the MDC 22 and a local office 50. At 110, once the MDC 22 receives the entire upgrade, the MDC 22 implements the upgrade.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a wireless mobile computing device that executes software contained therein; and
a host system configured to wirelessly communicate with said wireless mobile computing device;
wherein said host system verifies that the wireless mobile computing device is authorized to receive a software upgrade and, if so, wirelessly transmits data to said wireless mobile computing device to upgrade said software.

2. The system of claim 1 wherein said host system compares an identifier from said wireless mobile computing device to a list of known valid identifiers to verify the wireless mobile computing device.

3. The system of claim 2 wherein said identifier comprises a serial number.

4. The system of claim 1 wherein wireless computing device encrypts and wirelessly transmits an identifier value, that identifies said wireless computing device, to said host system for verification of said wireless mobile computing device.

5. The system of claim 1 wherein said host system comprises an indicator of the progress of the wireless transmission of said data.

6. The system of claim 5 wherein, if said wireless transmission of said data is interrupted, said host system resumes said wireless transmission of said data at the point of interruption.

7. The system of claim 1 wherein said wireless transmission of said data begins without a user prompt.

8. The system of claim 1 said wireless mobile computing device comprises a police mobile data computer.

9. A method, comprising:
detecting when a wireless mobile computing device is within wireless communication range;
verifying that said wireless mobile computing device is permitted to receive a software upgrade;
if said wireless mobile computing device is verified, wireless providing said software upgrade to said wireless mobile computing device; and
if said wireless mobile computing device is not verified, not providing said software upgrade to said wireless mobile computing device.

10. The method of claim 9 wherein verifying said wireless mobile computing device comprises comparing a value received from said wireless mobile computing against a list of known legitimate values.

11. The method of claim 10 wherein verifying said wireless mobile computing device comprises receiving an encrypted version of said value.

12. The method of claim 10 wherein verifying said wireless mobile computing device comprises decrypting said encrypted version.

13. The method of claim 9 wherein verifying said wireless mobile computing device comprises comparing a serial number received from said wireless mobile computing against a list of known legitimate serial numbers.

14. The method of claim 9 further dynamically tracking the progress of the providing of the software upgrade.

15. The method of claim 14 wherein, if the providing of the software upgrade is interrupted, further comprising resuming providing the software upgrade at the point of the interruption.

16. A system, comprising:
means for detecting when a wireless mobile computing device is within wireless communication range;
means for wirelessly transmitting a software upgrade to the wireless mobile computing device;
means for detecting when said software upgrade is interrupted before its completion; and
means for restarting wireless transmission of the software upgrade at the point of interruption.

17. The system of claim 16 further comprising means for verifying that said wireless mobile computing device is permitted to receive the software upgrade.

18. The system of claim 16 further comprising means for comparing a value received from the wireless mobile computing device to a database of values to verify that said wireless mobile computing device is permitted to receive the software upgrade.

19. The system of claim 18 wherein said database of values comprises valid serial numbers of mobile computing devices that are permitted to receive the software upgrade.

20. The system of claim 16 further comprising means for updating a pointer that identifies a current position in a software upgrade that is being transmitted to the wireless mobile communication device.
